(19) United States
(12) Patent Application Publication
(10) Pub. No.: US 2014/0026819 A1
(43) Pub. Date: Jan. 30, 2014

(54) Reconfigurable Cage Bank System For Confining One Or More Animals

(71) Applicants: Laryssa Chortyk White, Salem, MA (US); Sandra Jauron Siclari, Boston, MA (US); Lori Haraske, Amesbury, MA (US)

(72) Inventors: Laryssa Chortyk White, Salem, MA (US); Sandra Jauron Siclari, Boston, MA (US); Lori Haraske, Amesbury, MA (US)

(73) Assignee: PET EDGE, INC., Beverly, MA (US)

(21) Appl. No.: 13/556,307

(22) Filed: Jul. 24, 2012

(51) Int. Cl. A01K 1/03; A01K 1/02

(52) U.S. Cl. 119/455; 119/473

(57) ABSTRACT

Exemplary embodiments of the present disclosure relate to reconfigurable cage bank systems for confining one of more animals. The reconfigurable cage bank systems can include an enclosure and one or more dividers disposed within an interior area defined by the enclosure. The dividers can selectively divide the interior area into one or more animal holding areas each of which can be configured to confine an animal. The dividers can be adjustably and/or removeably positioned within the interior area of the enclosure to reconfigure one or more of the animal holding areas.

### BACKGROUND

Exemplary embodiments relate to reconfigurable cage bank systems for confining one or more animals.

Animal cages or crates are typically used by, for example, pet owners, breeders, animal clinics, kennels, pet stores, and/or animal adoption centers to confine one or more animals. An animal can typically enter the cage via a doorway, which can be closed once the animal is inside the cage to confine the animal within the cage. In some instances, a bank of cages can be implemented such that multiple cages can be formed in a side-by-side or stacked arrangement, wherein each cage in the bank of cages can hold at least one animal. Typically, the dimensions of these conventional cages are fixed.

Conventional fixed dimension cages typically require users to determine which cages to purchase based on the dimensions of the cages. As one example, a user may purchase cages that have dimensions that can accommodate large sized dogs and may use these cages to hold small, medium, and large sized dogs. While this approach provides flexibility to allow a single cage to hold different sized animals, this approach results in an inefficient use of space, which may be limited, because some animals generally do not require as much space as other animals. As another example, the user may purchase cages having an assortment of fixed dimensions such that the user can have cages that are dimensioned to hold small-sized dogs, cages to hold medium-sized dogs, and cages that hold large-sized dogs. While this approach can result in an efficient use of space, some of the cages may not have suitable dimensions to hold some animals, which can create an issue, for example, if the user acquires more large sized dogs than cages that can accommodate the large sized dogs.

### SUMMARY

Exemplary embodiments of the present disclosure relate to reconfigurable cage bank systems for confining one of more animals. The reconfigurable cage bank systems may include an enclosure and one or more dividers disposed within an interior area defined by the enclosure. The dividers can divide the interior area into one or more animal holding areas each of which can be configured to confine an animal. The dividers may be adjustably and/or removeably positioned within the interior area of the enclosure to adjust at least one dimension associated with one or more of the animal holding areas. The adjustably sized animal holding areas can allow a user to allocate the interior area of exemplary embodiments of the reconfigurable cage bank system based on a size of the animals to be held in the interior area to provide an efficient and flexible structure for confining one or more animals of similar and/or different sizes.

In one embodiment, a reconfigurable system for confining one or more animals is disclosed. The system includes an enclosure and a divider. The enclosure extends along a longitudinal axis and defines an interior area. The divider is disposed in the interior area of the enclosure to form two or more animal holding area. The divider is adjustably positioned within the interior area to adjust a dimension associated with at least one of the animal holding areas.

In another embodiment, a method of reconfiguring one or more animal holding areas is disclosed. The method includes positioning a divider within an interior area of an enclosure to a first location along a longitudinal axis of the enclosure. The interior area is accessible through one or more closable passageways disposed along a side of the enclosure. The divider defines a first animal holding area having a first width and a second animal holding area having a second width. The method also includes repositioning the divider within the interior area to a second location along the longitudinal axis to adjust each of the first width of the first animal holding area and the second width of the second animal holding area and securing the divider at the second location to impede movement of the divider from the second location.

In yet another embodiment, a system for confining one or more animals is disclosed that includes an enclosure and one or more dividers. The enclosure extends along a longitudinal axis and defines an interior area. The one or more dividers are disposed within the interior area to form a plurality of animal holding areas. The one or more dividers are adjustably positioned along a transverse axis within the interior area to reconfigure the plurality of animal holding areas.

Other objects and features will become apparent from the following detailed description considered in conjunction with the accompanying drawings, wherein like reference numerals identify like elements. It is to be understood, however, that the drawings are designed as an illustration only and not as a definition of the limits of the present disclosure.

### BRIEF DESCRIPTION OF THE DRAWINGS

FIG. 1 shows a perspective view of an exemplary embodiment of a reconfigurable cage bank system.

FIG. 2 shows another perspective view of the reconfigurable cage bank system of FIG. 1.

FIG. 3 shows a front side view of an exemplary embodiment of the reconfigurable cage bank system.

FIG. 4 is a side view of an exemplary embodiment of a divider that can be implemented in accordance with the present disclosure.

FIG. 5 is a perspective view of a portion of an exemplary embodiment of the reconfigurable cage bank system.

FIG. 6 shows a cross-sectional view of the reconfigurable cage bank system along line 6-6 of FIG. 5.

FIG. 7 is detailed view of area 7 in FIG. 5.

FIG. 8 is another detailed view of area 7 in FIG. 5.

FIG. 9 is another front side view of an exemplary embodiment of the reconfigurable cage bank system.

FIG. 10 shows an exemplary embodiment of a latching member of an exemplary door for embodiments of the reconfigurable cage bank system.

FIG. 11 shows a perspective view of another exemplary embodiment of a reconfigurable cage bank system.

FIG. 12 shows a top view of the reconfigurable cage bank system of FIG. 11.

FIG. 13 is a side view of another exemplary embodiment of a divider that can be implemented in accordance with the present disclosure.

FIG. 14 is a perspective view of a front body portion of the divider of FIG. 13.

FIG. 15 is a side cross-sectional view of the reconfigurable cage bank system of FIG. 11.

### DETAILED DESCRIPTION OF EXEMPLARY EMBODIMENTS

Exemplary embodiments of the present disclosure are directed to reconfigurable cage bank systems that can be configured to include adjustably sized animal holding areas for confining one or more animals, such as one or more dogs and/or one or more cats. Exemplary embodiments of the reconfigurable cage bank systems can include an enclosure defining an interior area that can be divided into the animal holding areas using one or more adjustably positioned dividers disposed in the interior area of the enclosure. A size of the animal holding areas can be adjusted by moving the dividers in the interior area.

Providing adjustably sized animal holding areas allows a user to allocate the interior area of exemplary embodiments of the reconfigurable cage bank system based on a size of the animals to be held in the interior area. Because smaller animals typically require less space than larger animals, a position of the dividers can be selected to provide the larger animals with a larger animal holding areas and the smaller animals with a smaller animal holding areas within the enclosure of the exemplary embodiments of the reconfigurable cage bank system. Exemplary embodiments of the reconfigurable cage bank system can provide an efficient and flexible structure for confining one or more animals of similar and/or different sizes.

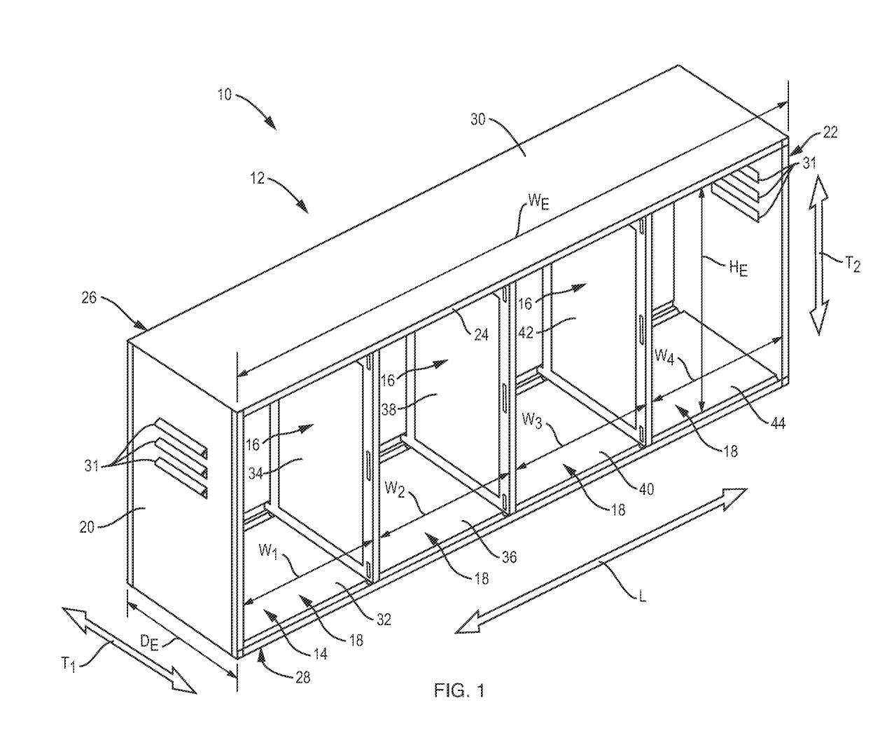

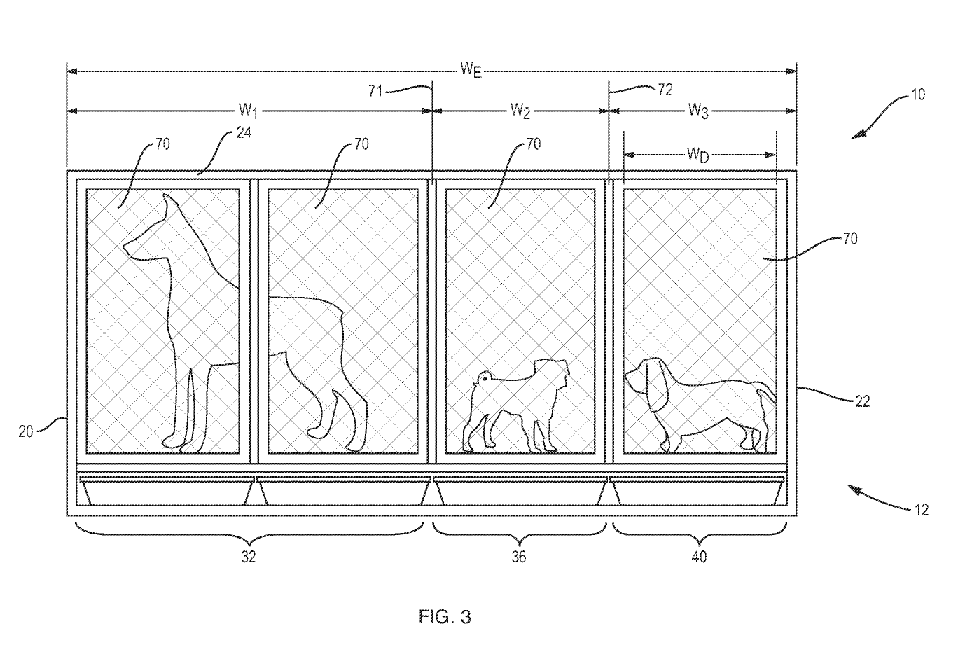

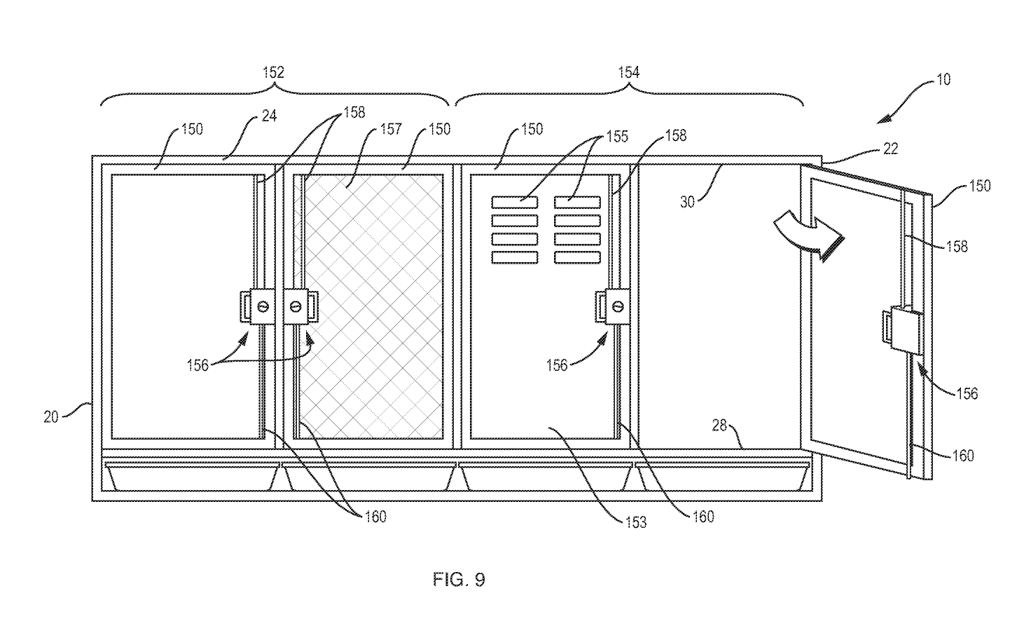

FIG. 1 shows a perspective view of an exemplary embodiment of a reconfigurable cage bank system 10 that includes an enclosure 12 having an interior area 14 dimensioned to hold one or more animals, such as one or more dogs and/or one or more cats. For clarity, one or more gating structures, such as one or more doors or gates, have been omitted from FIG. 1 to provide an unobstructed view of the interior area 14 of the enclosure 12. Exemplary gating structures, e.g., doors, are shown for example, in FIGS. 3 and 9. One or more dividers 16 can be disposed in the interior area 14 to form animal holding areas 18 (e.g., pens, bays, compartments) in which at least one animal can be confined. The dividers 16 can be adjustably positioned in the interior area 14 to adjust a size of the animal holding areas 18. In exemplary embodiments, the size of the animal holding areas 18 can be adjusted to accommodate different sized animals. For example, the reconfigurable cage bank system can hold different sized dogs, such as small dogs (e.g., Chihuahuas), medium dogs (e.g., Cocker Spaniels), large dogs (e.g., Golden Retrievers), and or a combination thereof, and the size of the animal holding areas 18 can be adjusted to correspond to the sizes of the dogs to be confined in the animal holding areas 18.

In the present embodiment, the enclosure 12 can generally extend along a longitudinal axis L from a first side 20 to a second side 22, can generally extend along a first transverse axis T₁, perpendicular to the longitudinal axis L, from a third (front) side 24 to a fourth (rear) side 26, and can generally extend along a second transverse axis T₂, perpendicular to the longitudinal axis L and the first transverse axis T₁, from a fifth (bottom) side 28 to a sixth (top) side 30. The sides 20, 22, 24, 26, 28, 30 of the enclosure 12 define the interior area 14 of the enclosure 12. In exemplary embodiments, the third (front) side 24 provides a passageway into and out of the interior area 14 and can be formed by gating structures, such as one or more doors, gates, and/or other structures configured to close the passageway. A width W_{E} of the interior area 14 defined by the enclosure 12 can be measured along the longitudinal axis L between the first and second sides 20 and 22. A depth D_{E} of the interior area 14 defined by the enclosure 12 can be measured along the first transverse axis T₁ between the third and fourth sides 24 and 26, and the height H_{E} of the interior area 14 defined by the enclosure 12 can be measured along the second transverse axis T₂ between the fifth and sixth sides 28 and 30. The interior area 14 has a generally continuous volume that can be divided into the animal holding areas 18 by the dividers 16. In some embodiments, one or more supporting columns can be disposed along the third side 24 and extending between the fifth and sixth sides 28 and 30. In some embodiments, the sides 20, 22, 24, 26, 28, 30 can be generally planer such that the enclosure 12 has a generally rectangular shape. In some embodiments, the sides 20, 22, 24, 26, 28, 30 can be curved or otherwise shaped such that the enclosure can be formed to have a shape other than a rectangle. In some embodiments, one or more of the sides 20, 22, 24, 26, 28, 30 can be configured to provide ventilation to the interior area 14 of the enclosure. For example, one or more of the sides 20, 22, 24, 26, 28, 30 can include a substantially continuous surface having slots, slits, and/or other openings 31 to facilitate circulation of air through the enclosure 12.

The quantity of animal holding areas 18 in the interior area 14 can be configured to be between a minimum quantity of animal holding areas and a maximum quantity of animal holding areas. A quantity of the dividers 16 disposed in the interior area 14 of the enclosure 12 can determine a maximum quantity of animal holding areas 18 that can be formed in the interior area 14. The minimum quantity of animal holding areas 18 formed in the interior area 14 is one animal holding area and can be independent of the quantity of dividers 16 disposed in the interior area 14. For example, the dividers 16 disposed in the interior area 14 can be positioned proximate to and/or against the sides 20 and/or 22 to form a single animal holding area 18 in the interior area 14.

In some embodiments, a user can remove one or more of the dividers 16 from the interior area 14 and/or insert one or more of the dividers into the interior area to determine a maximum quantity of animal holding areas 18 that can be formed in the interior area 14. In some embodiments, the dividers 16 cannot be readily removed from the assembled reconfigurable cage bank system 10 such that the maximum quantity of animal holding areas 18 is specified at the time of manufacture or assembly. If no dividers 16 are disposed in the interior area 14, a single animal holding area 18 can be formed having a generally fixed size. If one of the dividers 16 is disposed in the interior area 14, a maximum of two animal holding areas can be formed and a size of each animal holding area can be determined based on a position of the divider in the interior area 14. If two dividers 16 are disposed in the interior area 14, a maximum of three animal holding areas can be formed and a size of each of the animal holding areas 18 can be determined based on a position of at least one of the two dividers 16. If three dividers 16 are disposed in the interior area 14, a maximum of four animal holding areas 18 can be formed and a size of each of the animal holding areas 18 can be determined based on a position of at least one of the three dividers 16.

The dividers 16 can form boundaries between the animal holding areas 18 and can be moveably positioned in the interior area 14 along the longitudinal axis L to adjust a location of the boundaries between the animal holding areas 18 to change a size (e.g., width or volume) of one or more of the animal holding areas 18. For example, in the present embodiment, a width W₁ of a first animal holding area 32 can be measured along the longitudinal axis between the first side 20 and a first divider 34, a width W₂ of a second animal holding area 36 can be measured along the longitudinal axis L between the first divider 34 and a second divider 38, a width W₃ of a third animal holding area 40 can be measured along the longitudinal axis L between a second divider 38 and a third divider 42, and a width W₄ of a fourth animal holding area 44 can be measured along the longitudinal axis L between the third divider 42 and the second side 22.

The widths W₁-W₄ of the animal holding areas 32, 36, 40, and 44, respectively, can be adjusted by moving the dividers 16 in the interior area 14. As one example, the width W₁ can be adjusted by moving the first divider 34 with respect to the first side 20, the width W₂ can be adjusted by moving the first divider 34 and/or the second divider 38 with respect to each other, the width W₃ can be adjusted by moving the second divider 38 and third divider 42 with respect to each other, and the width W₄ can be adjusted by moving the third divider 42 with respect to the second side 22.

An orientation of the dividers 16 in the interior area 14 can be generally fixed with respect to the longitudinal axis L, the first transverse axis T₁, and/or the second transverse axis T₂ so, as the dividers are moved by the user, the dividers translate along the longitudinal axis L. For example, the dividers 16 can be disposed generally perpendicularly to the longitudinal axis L and generally parallel to the first and second transverse axes T₁ and T₂.

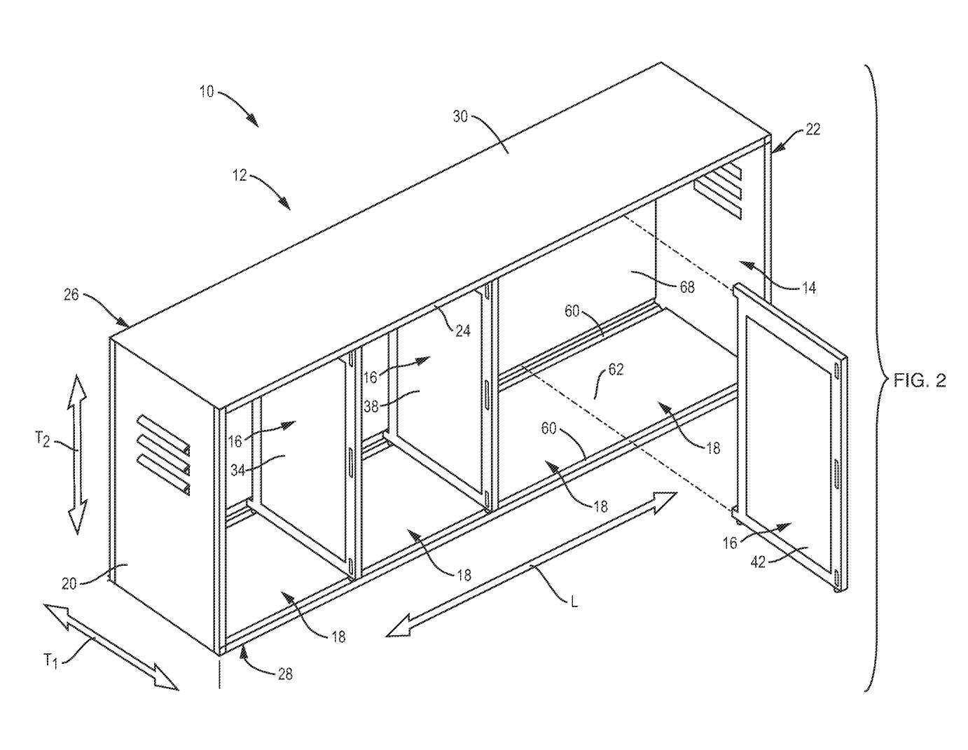

FIG. 2 shows a perspective view of the reconfigurable cage bank system 10 with one of the dividers 16 (e.g., the third divider 42) removed from the interior area 14. The interior area 14 can include two dividers 16 (e.g., the first divider 34 and the second divider 38) such that a maximum of three animal holding areas 18 can be formed in the interior area 14. One skilled in the art will recognize that the quantity of the dividers 16 included in the interior area 14 can be modified to form more or fewer animal holding areas 18.

As shown in FIG. 2, one or more interior surfaces of the enclosure 12 can include elongate tracks 60 extending along the longitudinal axis L. For example, one or more tracks 60 can be formed on an interior surface of one or more of the sides 20, 22, 24, 26, 28, 30 to generally fix an orientation of the dividers 16 in the interior area 14 and/or to guide the dividers 16 along the longitudinal axis L of the enclosure 12 to adjust the width of their respective animal holding areas 18. In exemplary embodiments, the tracks 60 can be slots, grooves, or channels formed as recesses or depressions in an interior surface of one or more of the sides 20, 22, 24, 26, 28, 30. As an example, an interior surface 62 of the fifth (bottom) side 28 can include one of the tracks 60 disposed proximate to the third (front) side 24 and can include another one of the tracks 60 disposed proximate to the fourth (rear) side 26. In exemplary embodiments, the tracks 60 disposed on the interior surface 62 can be substantially parallel to each other. As another example, an interior surface 68 of the fourth (rear) side 26 can include one or more of the track 60 disposed proximate to the fifth (bottom) side 28 and can include another one of the tracks 60 disposed proximate to the sixth (top) side 30. The tracks 60 disposed on the interior surface 68 can be substantially parallel to each other.

FIG. 3 is a front side view of the reconfigurable cage bank system 10 in which gating structures, e.g., doors 70, are disposed along the third (front) side 24 of the enclosure 12. Profiles of different sized dogs have been superimposed on the reconfigurable cage bank system 10 to illustrate a position of the dogs within the interior area of the enclosure 12. The reconfigurable cage bank system 10 can include four doors 70, each having a width W_{D}. In the present embodiment, the dividers (obscured) of the system 10 have been arranged to form different sized animal holding areas.

For example, the first divider (obscured) is positioned at a first location 71 and the second divider (obscured) is positioned at a second location 72 to form the animal holding areas 32, 36, and 40 having widths W₁, W₂, and W₃, respectively, within the width W_{E} of the interior area of the enclosure 12. The width W₁ of the first animal holding area 32 can be approximately twice the width W_{D} of one of the doors (i.e., two doors wide) and the widths W₂ and W₃ of the second and third animal holding areas 36 and 40 can each be approximately the width W_{D} of one of the doors (i.e., one door wide) such that the first animal holding area 32 is approximately twice as wide as the second and third animal holding areas 36 and 40. In the present embodiment, the first animal holding area 32 is dimensioned to hold up to a large sized dog (e.g. a Golden Retriever) and the second and third animal holding areas 36 and 40 are dimensioned to hold up to a medium sized dog.

The system 10 can be reconfigured by adding and/or removing dividers, and/or by moving one or more of the dividers within the interior area of the enclosure. For example, in the present embodiment, four animal holding areas can be formed that are each approximately the width W_{D} of one of the doors 70, two animal holding areas can be formed that are each approximately twice the width W_{D} of one of the doors 70, two animal holding areas can be formed where one of the animal holding areas is approximately three times the width W_{D} of one of the doors 70 and the other animal holding area is approximately the width W_{D} of one of the doors 70, a single animal holding area can be formed that is approximately four times the width W_{D} of one of the doors 70, and/or other combinations can be formed.

While the present embodiment illustrates adjusting the widths of the animal holding area to coincide with the width the doors 70, those skilled in the art will recognize that the widths of the animal holding areas are not limited to multiples of the width of the doors. Furthermore, in some embodiments, different gating structures can be implemented instead of, or in addition to, the doors 70 for which a width is not substantially fixed. For example, exemplary embodiments can be implemented using one or more of folding, scissor, retractable, roll-up, and/or accordion gates, and/or any other suitable gating structures. A variety of different combination of animal holding area widths can be implemented in accordance with the present disclosure.

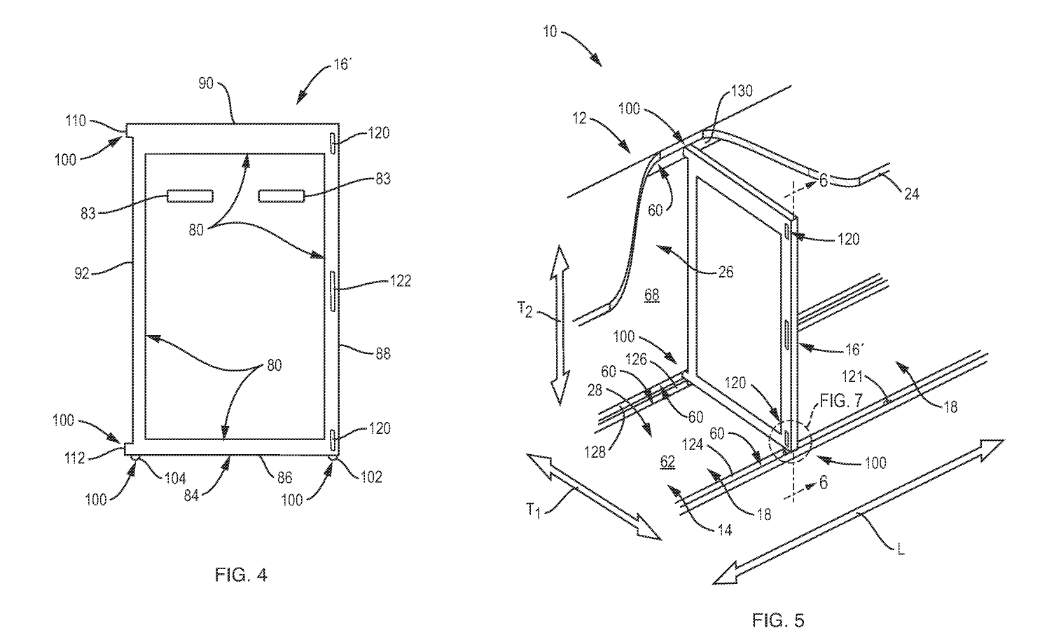

FIG. 4 shows a side view of one embodiment of a divider 16′ that can be implemented in accordance with the present disclosure for one or more of the dividers 16. The divider 16′ can have a perimeter 80 extending about a body portion 82. The perimeter 80 can be defined by an edge 84 having a first (bottom) edge portion 86, a second (front) edge portion 88, a third (top) edge portion 90, and a fourth (rear) edge portion 92. In exemplary embodiments, the body portion 82 can form a wall panel and the edge 84 can form a frame around the wall panel. The body portion 82 can include one or more openings 83 to permit airflow through the divider 16′.

The divider 16′ can include guide members 100 configured to engage the tracks 60 of the enclosure 12. The guide members 100 can include first and second guide members 102 and 104 that can extend from the first (bottom) edge portion 86. The first guide member 102 can be disposed proximate to the second (front) edge portion 88 and the second guide member 104 can be disposed proximate to the fourth (rear) edge portion 92. A position of the first and second guide members 102 and 104 with respect to the first (bottom) edge portion 86 can correspond to a position of the tracks 60 (FIGS. 1 and 2) disposed with respect to the fifth (bottom) side of the enclosure 12 such that when the divider 16′ is positioned in the interior area 14, the first guide member 102 aligns with one of the tracks 60 disposed with respect to the interior surface 62 and the second guide member aligns with another one of tracks 60 disposed with respect to the interior surface 62.

The guide members 100 of the divider 16′ can include third and fourth guide members 110 and 112 that can extend from the fourth (rear) edge portion 92 of the divider 16′. The third guide member 110 can be disposed proximate to the third (top) edge portion 90 and the fourth guide member 112 can be disposed proximate to the first (bottom) edge portion 86. A position of the third and fourth guide members 110 and 112 with respect to the fourth edge portion 92 can correspond to a position of one or more tracks 60 disposed with respect to the third (rear) side of the enclosure 12 such that when the divider 16′ is positioned in the interior area of enclosure, the third guide member 110 aligns with one of the tracks 60 and the fourth guide member 112 aligns with another one of the tracks 60.

In exemplary embodiments, the third and fourth guide members 110 and 112 can form projections extending rearwardly from the fourth (rear) edge portion 92 such that when the dividers 16 are positioned within the interior area 14 the third and fourth guide members 110 and 112 extend away from the fourth (rear) edge portion 92 along the first transverse axis T₁ to engage the tracks 60. The guide members 110 and 112 can facilitate translation of the divider 16′ along the longitudinal axis of the enclosure when the divider 16′ is moved within the interior area of the enclosure. In some embodiments, the third and fourth guide members 110 and 112 can be integrally formed with the fourth (rear) edge portion 92 such that the fourth (rear) edge portion 92 and the guide members 110 and 112 form a single continuous structure. In some embodiments, the third and fourth guide members 110 and 112 can be secured or fastened to the fourth (rear) edge portion 92.

The divider 16′ can include lockout members 120 configured to selective secure the divider 16′ at a location in the interior area of the enclosure. In exemplary embodiments, a first one of the lockout members 120 can be disposed proximate to the corner formed by the first (bottom) edge portion 86 and the second (front) edge portion 88 and a second one of the lockout members 120 can be disposed proximate to the corner formed by the second (front) edge portion 88 and the third (top) edge portion 90. The lockout member 120 can operate to selectively and substantially lock the divider 16′ in a position along the longitudinal axis when the divider 16′ is disposed within the interior area of the enclosure.

In some embodiments, the divider 16′ can include a handle 122 to provide an area on the divider 16′ that can be grasped by a user. The handle 122 can be disposed along the second (front) edge portion 88 and can extend along the second transverse axis T₂. In exemplary embodiments, the handle 122 can be positioned approximately midway between the first edge portion 86 and the third edge portion 90.

FIG. 5 is a perspective view of a portion of an exemplary embodiment of the reconfigurable cage bank system 10 having the divider 16′ disposed within the interior area 14 of the enclosure 12. The tracks 60 can be disposed with respect to each of the interior surface 62 of the fifth (bottom) side 28 and the interior surface 68 of the fourth (rear) side 26 and the guide members 100 of the divider 16′ can interact with the tracks 60.

The interior surface 62 of the fifth (bottom) side 28 can include a first track 124 and a second track 126 disposed with respect to the interior surface 62 of the fifth (bottom) side 28. The tracks 124, 126 can be spaced apart from each other such that the first track 124 is disposed proximate to the third (front) side 24 of the enclosure 12 and the second track 126 can be disposed proximate to the fourth (rear) side of the enclosure 12. The tracks 124, 126 can extend along the longitudinal axis L and can be substantially parallel to each other. In the present embodiment, the tracks 124, 126 can be recessed with respect to the interior surface 62, although those skilled in the will recognize that the tracks 124, 126 can be raised with respect to the interior surface 62.

The interior surface 68 of the fourth (rear) side 26 can include a third track 128 and a fourth track 130 disposed with respect to the interior surface 68 of the fourth (rear) side 26. The tracks 128, 130 can be spaced apart from each other such that the third track 128 is disposed proximate to the fifth (bottom) side 28 of the enclosure 12 and the fourth track 130 can be disposed proximate to the sixth (top) side 30 of the enclosure 12. The tracks 128, 130 can extend along the longitudinal axis L and can be substantially parallel to each other. In the present embodiment, the tracks 128, 130 can be recessed with respect to the interior surface 68, although those skilled in the will recognize that the tracks 128, 130 can be raised with respect to the interior surface 68.

When the divider 16′ is disposed within the interior area 14 of the enclosure 12, the first and second guide members 102 and 104 can align with the first and second tracks 124 and 126, respectively. The first and second guide members 102 and 104 can extend into the first and second tracks 124 and 126, respectively so that the first and second guide members 102 and 104 engage the first and second tracks 124 and 126. Likewise, when the divider 16′ is disposed within the interior area 14 of the enclosure 12, the third and fourth guide members 110 and 112 that can align with the third and fourth tracks 128 and 130, respectively. The third and fourth guide members 110 and 112 can extend into the third and fourth tracks 128 and 130, respectively so that the third and fourth guide members 110 and 112 engage the third and fourth tracks 128 and 130.

An interaction between the guide members 100 engage the tracks 60 can generally fix an orientation of the divider 16′ within the interior area 14 so that the divider 16′ is disposed generally perpendicular to the longitudinal axis L and disposed generally parallel the first and second transverse axes T₁ and T₂. In this orientation, the divider 16′ can form a barrier, such as a wall, that divides the interior area 14 of the enclosure to form separate and adjacent animal holding areas 18 within the interior area 14. The interaction between the guide members 100 and the tracks 60 can guide the movement of the divider 16′ so that the divider 16′ translates along the longitudinal axis L. For example, as a user urges the divider 16′ along the longitudinal axis L, the guide members 100 of the divider 16′ engages and/or slides within the tracks 60.

In some embodiments, the fifth (bottom) and sixth (top) sides 28 and 30 of the enclosure 12 can include corresponding receiving portions 121 configured to receive a portion of the lockout member 120 when the lockout member is in a protracted locked position. The receiving portions 121 can be formed as recesses in the interior surfaces of the fifth and sixth sides 28 and 30 proximate to the third side 24 of the enclosure 12 and can be distributed along the longitudinal axis L to provide discrete locations along the longitudinal axis at which the divider 16′ can be locked into place. In exemplary embodiments, the receiving portions 121 can be evenly and/or uniformly spaced along the longitudinal axis such that the widths of the animal holding areas can be discretely specified. For example, in some embodiments, the reconfigurable cage bank system 10 can include a quantity of discrete gating structures, e.g., doors, and the receiving portions can disposed in the enclosure 12 so that when the lockout members in the dividers are aligned with the receiving portions, each of the animal holding areas 18 are accessible through at least one of the doors. In some embodiments, the receiving portions 121 can be disposed in the first track 124.

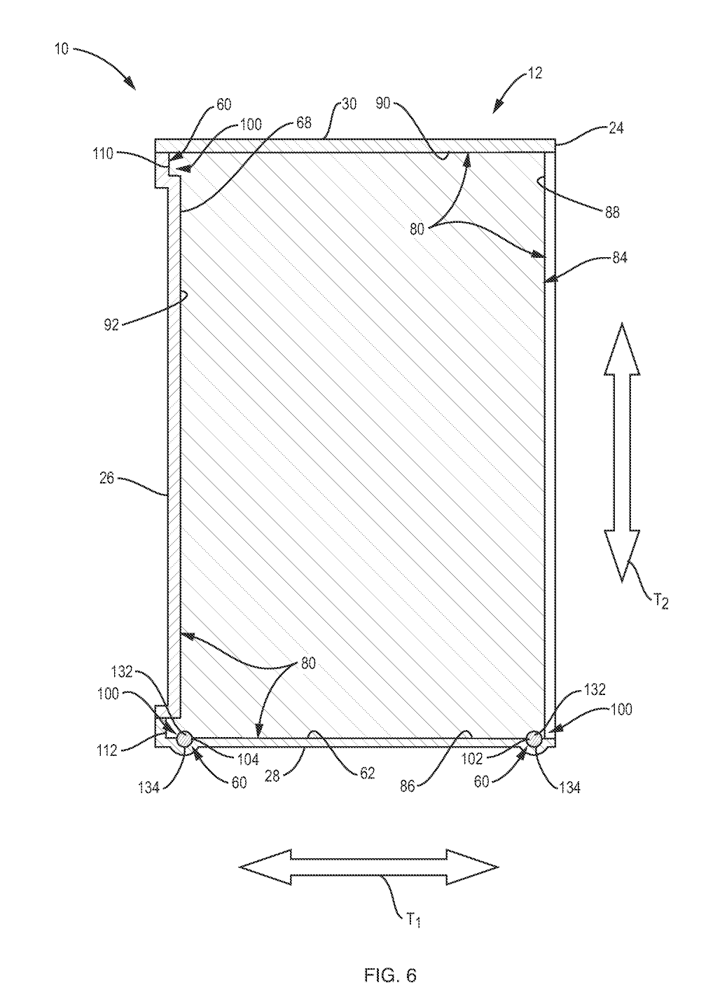

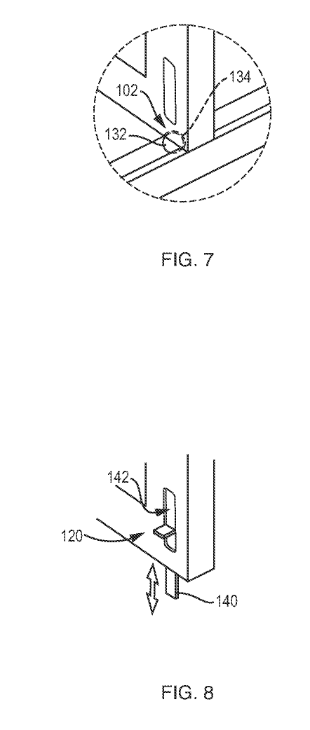

FIG. 6 is a cross-sectional view of the reconfigurable cage bank system 10 along the line 6-6 of FIG. 5. FIGS. 7 and 8 show a detailed view of the area 7 in FIG. 5. The lockout member 120 is omitted from FIG. 7 for clarity and the first guide member 102 and enclosure 12 are omitted from FIG. 8 for clarity. As shown in FIG. 6, in an exemplary embodiment, the perimeter 80 of the divider 16′ can generally conform to an outline of the interior area 14 of the enclosure 12 with respect to the first and second transverse axes T₁ and T₂. The first and second tracks 124 and 126 can have a generally rounded recessed profile, which can generally correspond to the profile of the first and second guide members 102 and 104. The third and fourth tracks 128 and 130 can have a generally rectangular recessed profile, which can generally correspond to the third and fourth guide members 110 and 112.

Referring to FIGS. 6 and 7, the first and second guide members 102 and 104 can each include a ball 132 that rotatingly engages a socket 134 formed in the first (bottom) edge portion 86 such that the first and second guide members 102 and 104 can form ball bearings. The ball 132 of each ball bearing can be free to rotate in the socket 134 and can engage its respective track (e.g., tracks 124 and 126) to facilitate sliding and/or rolling of the dividers along a longitudinal axis L. Forming the first and second guide members 102 and 104 using ball bearings can reduce friction between the divider 16′ and enclosure 12 to reduce an amount of force that is required to move the divider 16′ to change the size of the animal holding areas 18.

As shown in FIG. 8, an exemplary embodiment of the lockout member 120 can each include a shaft 140 moveably retained within in a channel 142 formed in the first (bottom) edge portion 86 and/or the second (front) edge portion 88 of the divider 16′. The shaft 140 can be moved between a retracted unlocked position and a protracted locked position, and can be moveable along the second transverse axis T₂ to move the shaft 140 between the retracted unlocked position and the protracted locked position. In the retracted unlocked position, the shaft 140 is retracted into the edge 80 of the divider 16′ so that movement of divider 16′ along the longitudinal axis L is unimpeded by the lockout member 120. In the protracted locked position the shaft 140 protrudes from the edge 80 of the divider 16′ and engages the enclosure 12 to selectively lock or secure the position of the divider 16′ so that movement of the divider 16′ along the longitudinal axis L is impeded by the lockout member 120. In some embodiments, the shaft 140 can be substantially aligned with the guide member 102 of the divider 16′ with respect to the second transverse axis T₂ such that when the shaft 140 is moved to the protracted locked position, the shaft 140 extends into the first track 124 (FIG. 5).

In some embodiments, the shaft 140 can be biased to the protracted locked position such that the protracted locked position is the nominal default position of the shaft 140. For example, the lockout members 120 can each include a biasing member, e.g., a spring (not shown), which urges the shaft 140 to the protracted locked position. For embodiments in which the shaft 140 is biased in the protracted locked position, the shaft 140 can be moved to the retracted unlocked position by overcoming the force of the spring. In some embodiments, a position of the divider 16′ can selectively secured along the longitudinal axis L in the interior area 14 of the enclosure using a friction force between the shaft 140 and the enclosure 12 generated by the biasing member of the lockout member 120. In some embodiments, a position of the divider 16′ can selectively secured along the longitudinal axis L in the interior area 14 of the enclosure using an interaction between the shaft 140 and the receiving portions of the enclosure so that at least a portion of the shaft 140 of the lockout member 120 nests within one of the receiving portions.

FIG. 9 illustrates an exemplary embodiment of the reconfigurable cage bank system 10 having one or more gating structures, e.g., doors 150, mounted along the third (front) side 24 of the enclosure 12 in a side-by-side arrangement to provide passageways for entering and exiting the interior area 14 of the enclosure. Each of the doors 150 can be mounted to the third (front) side 24 of the enclosure by one or more hinges (not shown) such that each of the doors 150 can rotate about their respective hinges between an open position in which one or more animals is allowed to enter and/or exit their respective animal holding areas 18 and a closed position in which one or more animals are confined to their respective animal holding areas 18. The doors 150 can be opened and closed independently and separately from the each other such that when a door is opened a passageway or opening is formed in the third (front) side 24 of the enclosure 12.

In some embodiments, one or more of the doors 150 can have a continuous surface 153 and can include openings 155 for facilitate ventilation. In some embodiments, one or more of the doors 150 can have a surface with a lattice pattern 157 or other generally open pattern, such as, e.g., chain-linked fencing, so that when the doors 150 are closed there is a substantial amount of openings through which air can flow, while confining the animal to the interior area. In some embodiments, the doors 150 can be configured to allow a substantial amount of light to enter the interior area 14 of the enclosure 12.

In the present embodiment, the reconfigurable cage bank system 10 the doors 150 can be configured in pairs. For example, the reconfigurable cage bank system 10 can include a first pair 152 of doors 150 and a second pair 154 of doors 150 such that a total of four doors 150 are disposed along the third (front) side 24 of the enclosure 12.

The doors 150 of the first pair 152 are adjacent to each other and hinged on opposite sides so that each of the doors 150 in the first pair 152 can open away from each other and close towards each other. For example, when each of the doors 150 in the first pair 152 are in the open position a first double wide opening (i.e., approximately two door widths) is formed in the enclosure 12 that is approximately the width of the first pair 152 of doors 150 and when each of the doors 150 in the first pair 152 are closed, the first double wide opening is substantially blocked by the doors 150 of the first pair 152.

Likewise, the doors 150 of the second pair 154 are adjacent to each other and hinged on opposite sides so that each of the doors 150 in the second pair 154 can open away from each other and close towards each other. For example, when each of the doors 150 in the second pair 154 are in the open position a second double wide opening is formed in the enclosure 12 that is approximately the width of the second pair 154 of doors 150 and when each of the doors 150 in the second pair 154 are closed, the second double wide opening is substantially blocked by the doors 150 of the second pair 154.

The first and second pairs 152 and 154 of doors 150 can be adjacent disposed such that the door of the first pair 152 that is adjacent to the door of the second pair 154 open towards each other and close away from each other. For example, when each of the doors 150 in the first and second pair 152 and 154 are in the open position the first and second openings are formed in the enclosure 12 and the first and second double wide openings are divided generally midway between the first and second sides 20 and 22 of the enclosure 12 by the open doors 150 of the first and second pairs 152 and 154 that are adjacent to each other.

One or more of the doors 150 can include a latching member 156 to facilitate opening and closing of the doors 150 as well as to facilitate securing the doors 150 in the closed positioned. The latching member 156 can be a spring loaded hinge system that includes a first shaft 158 and a second shaft 160 extending in opposite direction along the second transverse axis T₂. The shafts 158 and 160 can move between a first retracted open position and a second protracted locked position. When the shafts 158 and 160 are in the first retracted open position, the shafts 158 and 160 are retracted into the frame of the door to allow the user to open and close the door. When the shafts 158 and 160 are in the protracted locked position the shafts 158 and 160 extend from the frame of the door and engage the sixth (top) side 30 and fifth (bottom) side 28 of the enclosure to secure the door in a closed position to impede the door from opening.

While the present embodiment includes four doors 150 those skilled in the art will recognize that more or fewer doors 150 can be disposed on the enclosure 12. Furthermore, those skilled in the art will recognize that other gating structures can be implemented instead of, or in addition to, the doors 150. For example, exemplary embodiments can be implemented using one or more of folding, scissor, retractable, roll-up, and/or accordion gates, and/or any other suitable gating structures.

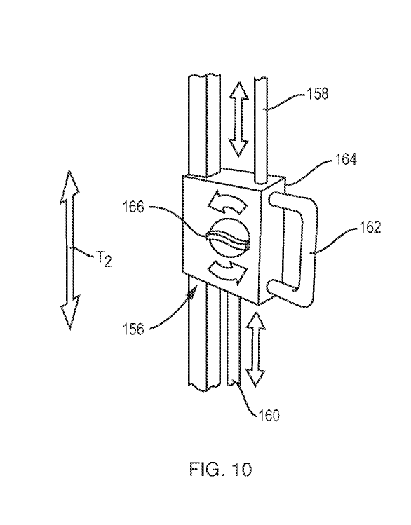

FIG. 10 shows an exemplary embodiment of the latching member 156 that can be implemented for one or more of the doors 150 of FIG. 9. As shown in FIG. 10, the latching member 156 can include a handle portion 162 and a latching portion 164. The handle portion 162 can extend from the latching portion 164 and can provide an area that can be grasped by the user when opening and/or closing the doors. The latching portion 164 can include the first shaft 158 and a second shaft 160 extending in opposite direction from each other. The first and second shafts 158 and 160 can be laterally offset from each other and can each extend along the second transverse axis T₂. Each of the shafts 158 and 160 can terminate in the latching portion 164 and can be operatively coupled to an actuating member 166. The actuating member 166 can be rotated in a clockwise and/or counter clockwise manner to actuate the first and second shafts 158 and 160. For example, when the actuating member 166 is rotated in the clockwise direction, the shafts 158 and 160 can move along the second transverse axis T₂ towards each other to the retracted open position and when the actuating member 166 rotated counter clockwise, the shafts 158 and 160 can move along the second transverse axis T₂ away from each other to the protracted locked position. In exemplary embodiments, the shafts 158 and 160 can move in substantial unison when the actuating member 166 is rotated.

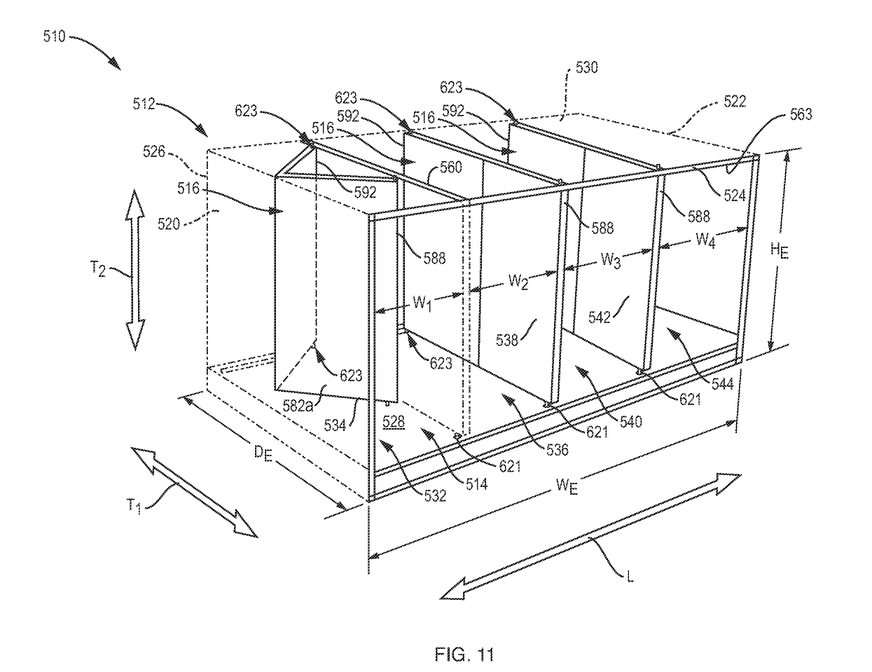

FIG. 11 shows a perspective view of another exemplary embodiment of a reconfigurable cage bank system 510 that includes the enclosure 512 having the interior area 514 dimensioned to hold one or more animals, such as one or more dogs and/or one or more cats. For clarity, the sides 520, 522, and 530 of the enclosure 512 have been shown as being transparent and one or more gating structures, such as one or more doors or gates, have been omitted from FIG. 11 to provide an unobstructed view of the interior area 514 of the enclosure 512. In exemplary embodiments, the reconfigurable cage bank system 510 can include gating structures, e.g., doors, as described with respect to FIGS. 3, 9, and 10 of the present disclosure.

The enclosure 512 can generally extend along the longitudinal axis L from the first side 520 to the second side 522, can generally extend along the first transverse axis T₁, perpendicular to the longitudinal axis L, from the third (front) side 524 to the fourth (rear) side 526, and can generally extend along the second transverse axis T₂, perpendicular to the longitudinal axis L and the first transverse axis T₁, from the fifth (bottom) side 528 to the sixth (top) side 530. The width W_{E} of the interior area 514 defined by the enclosure 512 can be measured along the longitudinal axis L between the first and second sides 520 and 522. The depth D_{E} of the interior area 514 defined by the enclosure 512 can be measured along the first transverse axis T₁ between the third and fourth sides 524 and 526, and the height H_{E} of the interior area 514 defined by the enclosure 512 can be measured along the second transverse axis T₂ between the fifth and sixth sides 528 and 530.

One or more dividers 516 can be disposed in the interior area 514 to selectively form the animal holding areas 518 (e.g., pens, bays, compartments) in which at least one animal can be confined. In this embodiment, the dividers 516 can be foldable or collapsible along the first transverse axis T₁ to move the dividers 516 between a folded retracted position and an unfolded protracted position in the interior area 514. In the folded retracted position, a divider 516 can be folded or otherwise positioned against and/or proximate to the fourth (rear) side 526 of the enclosure 512. In the unfolded protracted position, a divider extends along the first transverse axis T₁ to define a boundary between two or more animal holding areas 518. The dividers 516 can be moved between the folded retracted position and the unfolded protracted position in the interior area 514 and along the first transverse axis T₁ to adjust a quantity and size (e.g., width or volume) of the animal holding areas 518. A position of the dividers 516 can be generally fixed with respect to the longitudinal axis L of the enclosure 512 when the dividers 516 are in the unfolded protracted position.

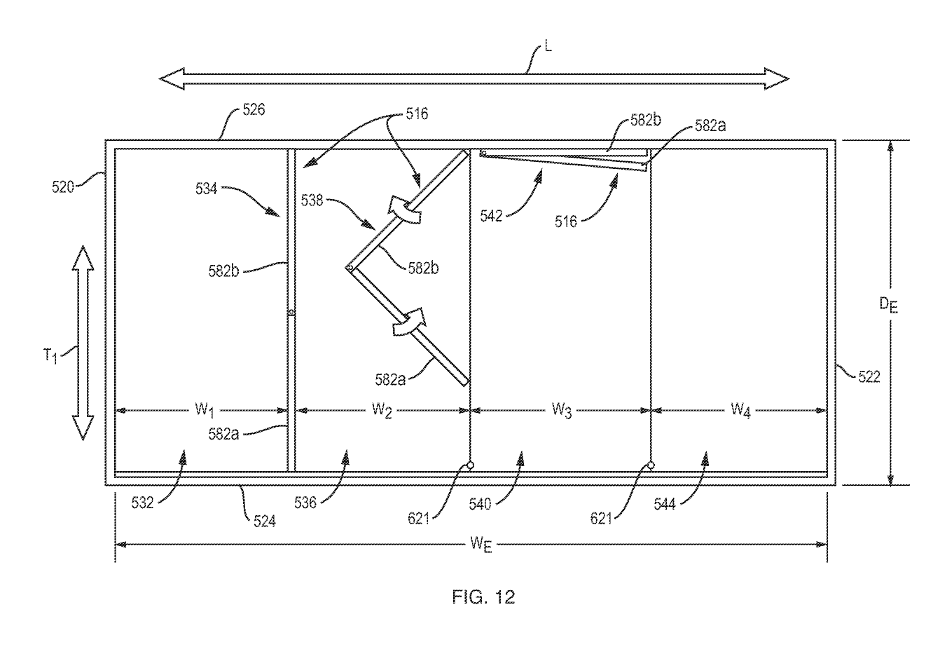

FIG. 12 is a top view of the reconfigurable cage bank system 510. For clarity, the sixth (top) side 530 of the enclosure 512 is shown as being transparent in FIG. 12 to provide an unobstructed view of the interior area 514 of the enclosure 512. FIG. 12 shows the dividers 516 in different positions along the first transverse axis T₁. For example, the dividers 516 can include a first divider 534 shown in the unfolded protracted position, a second divider 538 shown to be in between the folded retracted position and the unfolded protracted position, and a third divider 542 shown in the folded retracted position.

As shown in FIG. 12, in an exemplary unfolded protracted position, the first divider 534 generally forms a planar structure forming a boundary between the first and second animal holding areas 532 and 536. A front body portion 582a and a rear body portion 582b are aligned side-by-side in parallel relation with respect to each other and along the first transverse axis T₁. In the unfolded protracted position, the first divider 534 extends from the from the fourth (rear) side 526 of the enclosure 512 to the third (front) side 524 of the enclosure 512.

In an exemplary transition between the unfolded protracted position and the folded retracted position, as shown by the second divider 538, the front body portion 582a is configured to rotate in one direction (e.g., counterclockwise) and the rear body portion 582b is configured to rotate in another direction (e.g., clockwise). In transition between the unfolded protracted position and the folded retracted position, the front body portion 582a and the rear body portion 582b have an angular offset from each other and from the first transverse axis T₁.

In an exemplary retracted folded position, the third divider 542 is generally collapsed towards the fourth (rear) side 526 of the enclosure. The front body portion 582a and the rear body portion 582b can be generally parallel to each other and parallel to the longitudinal axis L. The front body portion 582a and the rear body portion 582b can have an overlapping side-by-side relationship such that an extent of the front body portion 582a and an extent of the rear body portion 582b are aligned with respect to the longitudinal axis and offset with respect to the first transverse axis T₁.

Referring now to FIGS. 11 and 12, the quantity of animal holding areas 518 in the interior area 514 can be configured to be between a minimum quantity of animal holding areas and a maximum quantity of animal holding areas using the dividers 516. A quantity of the dividers 516 disposed in the interior area 514 of the enclosure 512 can determine a maximum quantity of animal holding areas 518 that can be formed in the interior area 514. In this embodiment, the interior area 514 can include three dividers 516 (e.g., a first divider 534, a second divider 538, and a third divider 542) such that a maximum of four animal holding areas 518 can be formed in the interior area 514. The minimum quantity of animal holding areas 518 formed in the interior area 514 is one animal holding area and can be independent of the quantity of dividers 516 disposed in the interior area 514. For example, the dividers 516 disposed in the interior area 514 can each be independently moved to fold retracted position to fold the dividers 516 against the fourth (rear) side 526 to form a single animal holding area 518 in the interior area 514. One skilled in the art will recognize that the quantity of the dividers 516 included in the interior area 514 of exemplary embodiments can be modified to define a maximum quantity of the animal holding areas 518 that can be formed in the interior area 514.

When each of the dividers 516 are disposed in the unfolded protracted position, a width W₁ of a first animal holding area 532 can be measured along the longitudinal axis between the first side 520 and a first divider 534, a width W₂ of a second animal holding area 536 can be measured along the longitudinal axis L between the first divider 534 and a second divider 538, a width W₃ of a third animal holding area 540 can be measured along the longitudinal axis L between the second divider 538 and the third divider 542, and a width W₄ of a fourth animal holding area 544 can be measured along the longitudinal axis L between the third divider 542 and the second side 522.

Adjacent animal holding areas 18 can be merged together by moving a divider forming the boundary between the adjacent to the folded retracted position. As one example, the first divider 534 can be positioned in the folded retracted position and the second and third dividers 538 and 542 can be positioned in the unfolded protracted position such that there is no boundary between the first animal holding are 532 and the second animal holding area 536. In this example, the first and second animal holding areas 532 and 536 have merged into a single animal holding area having a width that is substantially equal to sum of the widths W₁ and W₂. Likewise, the first and second dividers 534 and 538 can be positioned in the folded retracted position and the third divider 542 can be positioned in the unfolded protracted position such that there is no boundary between the first, second, and third animal holding 532, 536, and 540 such that the first, second, and third animal holding areas 532, 536, 540 have merged into a single animal holding area having a width that is substantially equal to sum of the widths W₁, W₂, and W₃. In some embodiments, the widths W₁-W₄ can be approximately equal to each other.

In exemplary embodiments, each of the widths W₁-W₄ can be approximately equal to a width of a door 150 (FIG. 9) such that when each of the dividers 534, 538, 542 are in the unfolded protracted position to define the animal holding areas 532, 536, 540, 544, each of the animal holding areas 532, 536, 540, 544 can be associated with a corresponding door forming a passageway for entry and egress from the respective animal holding area. Likewise, in exemplary embodiments, for example, when the first divider 534 and/or the third divider 536 are in the retracted position animal holding can be formed between the first side 520 and the second divider 538 and/or between the second divider 538 and the second side 522, and the animal holding area can be approximately twice the width of one of the doors (FIG. 9).

One or more interior surfaces of the enclosure 512 can include elongate tracks 560 extending along the first transverse axis T₁ between the third (front) side 524 and the fourth (rear) side 526. For example, one or more tracks 560 can be formed on or with respect to an interior surface of the sixth (top) side 530. The tracks 560 can receive guide members of the dividers 516 to guide the dividers 516 between the folded retracted position and the unfolded protracted position in the interior area 514 to adjust a quantity and size of the animal holding areas 518. In exemplary embodiments, the tracks 560 can be slots, grooves, or channels formed as recesses or depressions in the interior surface of the sixth (top) side 530. In exemplary embodiments, the tracks 560 disposed on the interior surface 563 can be substantially parallel to each other.

A rear end 592 of each of the dividers 516 can be pivotally or rotatably secured within the interior area proximate to the fourth (rear) side 526 of the enclosure 512 in the interior area 514 and a front end 588 of each of the dividers 516 can be secured to the track 560. As the dividers 516 are moved between the folded retracted position and the unfolded protracted position or vice versa, the rear end 592 of the dividers 516 pivot and the front end 588 of the dividers 516 slide or translate along the first transverse axis T₁ with respect to the track 560.

In exemplary embodiments, the fifth (bottom) and sixth (top) sides 528 and 530 of the enclosure 512 can include receiving portions 621 configured to receive a portion of the dividers 516 to lock the dividers 516 in the unfolded protracted position and receiving portions 623 configured to receive a portion of the dividers 516 to pivotally secure the dividers 516 to the enclosure 512. The receiving portions 621 can be formed as recesses in the interior surfaces of the fifth and sixth sides 528 and 530 proximate to the third (front) side 524 of the enclosure 512 and the receiving portions 623 can be formed as recesses in the interior surfaces of the fifth and sixth sides 528 and 530 proximate to the fourth (rear) side 526 of the enclosure 512. The receiving portions 621, 623 can be distributed along the longitudinal axis L to provide discrete locations along the longitudinal axis at which the dividers 516 can respectively be locked into place and pivotally secured to the enclosure 12.

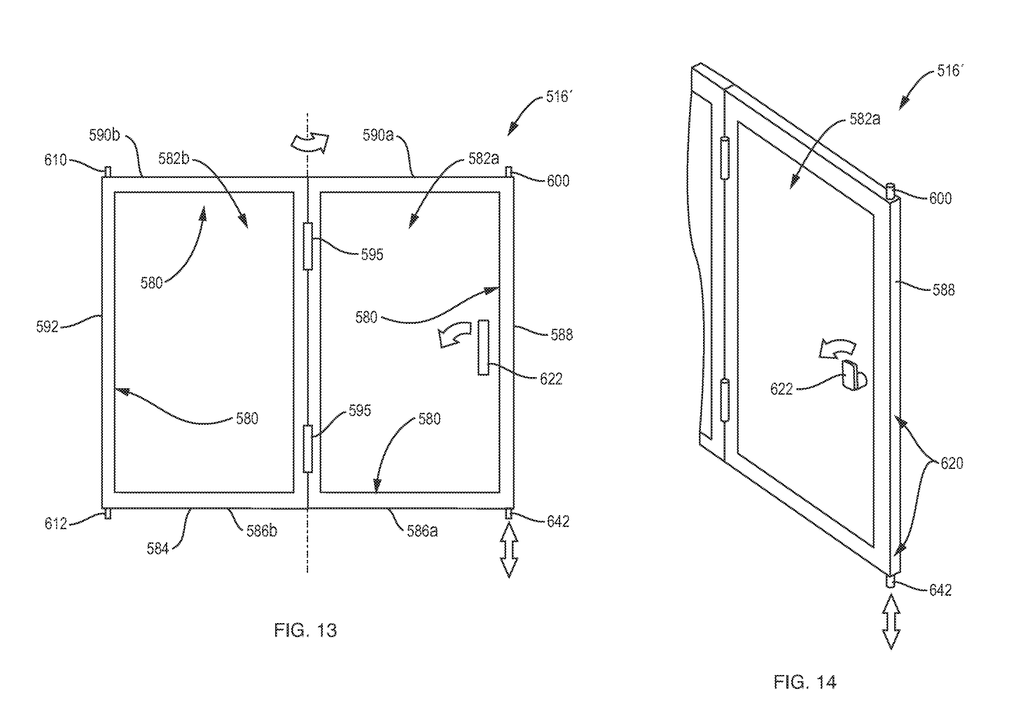

FIG. 13 shows a side view of one embodiment of the divider 516. In this embodiment, the divider 516 can be formed by front and rear body portions 582A and 582B that are connected via one or more joint members, e.g., hinges 595, such that the first and second body portions 582A and 582B are rotatable with respect to each other about an axis of rotation to form a bi-folding structure. While the present embodiment of the divider 516 is illustrated as a bi-folding structure, those skilled in the art will recognize that other folding or retractable structures can be used to for the divider 516. For example, exemplary embodiments of the divider 516 can be formed by a roll-up retractable structure, an accordion structure, a telescoping structure, and/or any other suitable folding or retractable structures.

The divider 516 can have a perimeter 580 extending about first and second body portions 582A and 582B. The perimeter 580 can be defined by an edge 584 having first (bottom) edge portions 586A and 586B, a second (front) edge portion 588, third (top) edge portions 590A and 590B, and a fourth (rear) edge portion 592. In exemplary embodiments, the first and second body portions 582A and 582B can form a wall panel and the edge 584 can form a frame around the wall panel.

A guide member 600 extending from the divider 516 can be configured to engage one of the tracks 560 of the enclosure 512 (FIGS. 11 and 12). In this embodiment, the guide member 600 can extend from the third top edge portion 590A along the second transverse axis T₂. The guide member 600 can be disposed proximate to the corner formed by the third (top) edge portion 590A and the second (front) edge portion 588. In exemplary embodiments, the guide member 600 can be formed as a projection or pin that can be received by one of the tracks of the enclosure 512. The guide member 600 can be configured to slide or translate along and/or within the track to facilitate guided movement of the divider between the folded retracted position and the unfolded protracted position. The guide member 600 can also be configured to permit the front body portion of the divider 516 to rotate as the divider 516 is moved between the folded retracted position and the unfolded protracted position.

Pivot members 610, 612 of the divider 516 can be figured to pivotally secure the divider 516 to enclosure 512 (FIGS. 11 and 12). In this embodiment, the pivot members 610, 612 can extend along the second transverse axis T₂ from the first (bottom) edge portion 586B and the third top edge portion 590B. The pivot member 610 can be disposed proximate to the corner formed by the third (top) edge portion 590B and the fourth (rear) edge portion 592 and the pivot member 612 can be disposed proximate to the corner formed by the first (bottom) edge portion 586B and the fourth (rear) edge portion 592. In exemplary embodiments, the pivot member 600 can be formed as a projections or pins that can be received by receiving portions 623 of the enclosure 512 (FIG. 11). The pivot members 610, 612 can be configured to engage and fit within the receiving portions 623 (FIG. 11) to facilitate rotation of the rear body portion of the divider 516 as the divider 516 is moved between the folded retracted position and the unfolded protracted position.

FIG. 14 illustrates a perspective view of the front body portion of the divider 516 illustrated in FIG. 13. The divider 516 can include a lockout member 620 configured to selectively secure the divider 516 in the unfolded protracted position in the interior area of the enclosure. The lockout member 620 can operate to selectively and substantially lock the divider 516 in a position along the longitudinal axis when the divider 516 is disposed within the interior area of the enclosure. The lockout member 620 can include a rod or shaft 642 extending along the second transverse axis T₂ and an actuating member, e.g., a handle 622, operatively coupled to the shaft 642. The shaft 642 can protrude from the divider 516 proximate to the corner formed by the first (bottom) edge portion 586A and the second (front) edge portion 588.

The handle 622 can be actuated to move the shaft along the second transverse axis T₂ between a released position and a locked position. In the released position, the shaft is retracted and/or urged upwardly into the divider 516. In the locked position, the shaft is protracted and/or urged downwardly out of the divider 516. For example, when the divider 516 is in the unfolded protracted position, the shaft 642 can be aligned with a corresponding receiving portion of the enclosure along the second transverse axis T₂, and the handle 622 can be actuated to urge the shaft along the second transverse axis T₂ and into the corresponding receiving area to secure the divider 516 in the unfolded protracted position to form a barrier between adjacent animal holding areas.

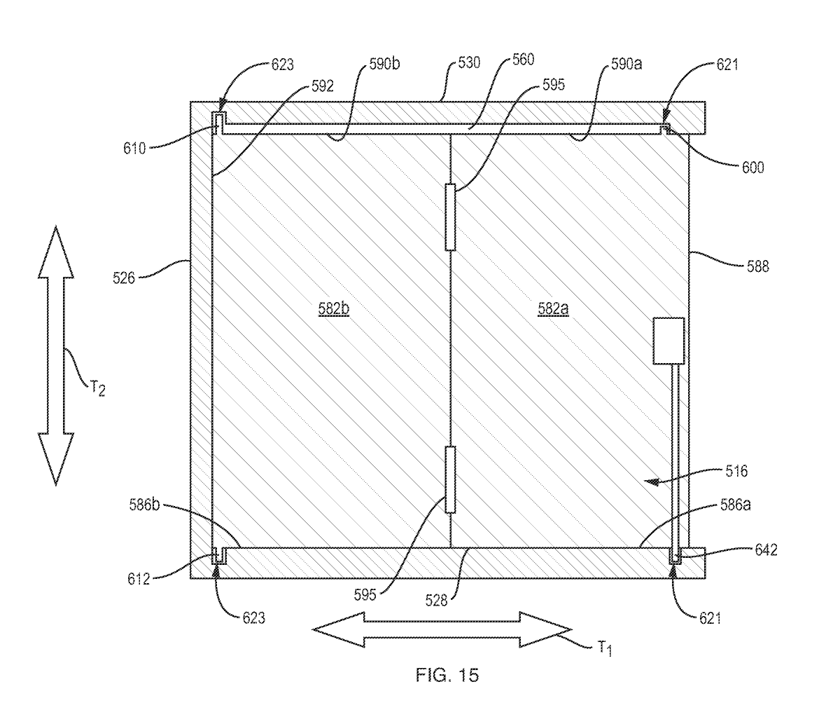

FIG. 15 shows a side cross-sectional view of the reconfigurable cage bank system of FIG. 11. As shown in FIG. 15, in an exemplary embodiment, the perimeter 580 of the divider 516 can generally conform to an outline of the interior area of the enclosure with respect to the first and second transverse axes T₁ and T₂. The divider 516 is shown in the unfolded protracted position in FIG. 15 such that the divider 516 extends along the first transverse axis T₁ to define a boundary between two or more animal holding areas.

The rear end 592 of the divider 516 can be pivotally or rotatably secured within the interior area proximate to the fourth (rear) side 526 of the enclosure in the interior area. For example, one of the receiving portions 623 can be formed as a recess in the sixth top surface 530 of the enclosure proximate to the fourth rear side 526 and can be configured to receive the pivot member 610 protruding from the third top edge portion 590b of the rear body portion 582b of the divider 516. Likewise, one of the receiving portions 623 can be formed as a recess in the fifth bottom surface 528 of the enclosure and can be configured to receive the pivot member 612 protruding from the first bottom edge portion 586b of the rear body portion 582b of the divider 516. The pivot members 610, 612 can engage the receiving portions 623 to pivotally secure the divider 516 to enclosure.

The track 560 can receive the guide member 600 extending from the third top edge portion 590a of the front body portion 582a of the divider 516 proximate to the front edge 588 of the divider 516. The guide member 600 can guide the divider 516 between the folded retracted position and the unfolded protracted position in the interior area of the enclosure. In exemplary embodiments, the track 560 can be a slot, groove, or channel formed as recesses or depressions in the interior surface of the sixth (top) side 530. In the present embodiment, the pivot member 610 can extend further from the top edge of the divider 516 than the guide member 600 and the corresponding receiving portion 623 be further recessed in the track 560 such that the pivot member 610 engages the receiving portion and the guide member can be positioned along the track between the pivot member 623 and the edge of the track 560 at the front side of the enclosure 512.

In exemplary embodiments, the fifth (bottom) side 528 of the enclosure 512 can includes the receiving portion 621 configured to receive the shaft 642 which can retractable extends from the first bottom edge portion 586a of the divider 516 to selectively lock the dividers 516 in the unfolded protracted position as described herein.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A reconfigurable system for confining one or more animals comprising:
an enclosure extending along a longitudinal axis and defining an interior area; and
one or more dividers disposed in the interior area of the enclosure to form two or more animal holding areas, the divider being adjustably positioned within the interior area to adjust a dimension of at least one of the animal holding areas.

2. The system of claim 1, wherein the one or more dividers are moveable within the interior area of the enclosure between a protracted position in which the divider forms a boundary between adjacent animal holding areas and a retracted position in which the boundary is removed.

3. The system of claim 2, wherein the one or more dividers comprise a lockout member to selectively secure the one or more dividers in the protracted position.

4. The system of claim 2, wherein the one or more dividers comprises a front body portion and a rear body portion operatively coupled by a joint about which the front body portion and the rear body portion rotate.

5. The system of claim 3, wherein the one or more dividers are configured to fold about the joint to move the one or more dividers within the interior area along a transverse axis of the enclosure between the protracted position and the retracted position.

6. The system of claim 1, wherein a rear end of the one or more divider is pivotally secured within the interior area.

7. The system of claim 1, wherein the enclosure comprises a first closable passageway to provide an entrance to a first one of the two or more animal holding areas and a second closeable passageway to provide an entrance to a second one of the two or more animal holding areas.

8. The system of claim 1, wherein the enclosure comprises a first track disposed in the interior area extending along a transverse axis of the enclosure and the one or more dividers comprise a first guide member, the first guide member interacting with the first track to guide the one or more dividers along the transverse axis.

9. The system of claim 8, wherein the first track is disposed along an interior surface of a top side of the enclosure and extends between a front side of the enclosure and a rear side of the enclosure.

10. The system of claim 1, wherein the one or more dividers comprises at least two dividers and the two or more animal holding areas comprises three animal holding areas, a first animal holding area and a second animal holding area being adjacent to a third animal holding area, a first one of the dividers being adjustably positioned within the interior area to adjust a size of each of the first and third animal holding areas, a second one of the dividers being adjustably positioned within the interior area to adjust a size of each of the second and third animal holding areas.

11. The system of claim 1, wherein the enclosure includes a plurality of doors disposed along a side of the enclosure to provide an entrance to the interior area.

12. The system of claim 11, wherein the plurality of doors comprises a first pair of doors and a second pair of doors in a side-by-side arrangement, each of the doors in the first and second pairs having a door width, the doors in the first pair being hinged on opposite sides so that when the doors in the first pair are in an open position an opening is formed to the interior area that is approximately twice the door width.

13. The system of claim 12, further comprising a plurality of dividers positioned in the interior area at a first plurality of locations along the longitudinal axis to form a first animal holding area that coincides with the opening so that the first animal holding area is approximately twice the door width and the opening forms a single passageway into the animal holding area, and
wherein at least one of the plurality of dividers is moveable within the interior area along the transverse axis from a retracted position to a protracted position so that the first animal holding is approximately the door width and the opening forms two passageways, a first one of the two passageway defining an entrance to the first animal holding area and a second passageway defining an entrance to a second animal holding area.

14. The system of claim 1, wherein the enclosure comprises a first track disposed in the interior area extending along the longitudinal axis and the divider comprises a first guide member, the first guide member interacting with the first track to guide the one or more dividers along the longitudinal axis.

15. The system of claim 14, wherein the first track is disposed along an interior surface of a bottom side of the enclosure and proximate to a front side of the enclosure, the first track is recessed in the interior surface of the bottom side and the first guide member comprises a ball bearing configured to roll along the first track.

16. A method of reconfiguring one or more animal holding areas comprising:
positioning a divider within an interior area of an enclosure to a protracted position along a transverse axis of the enclosure, the interior area being accessible through one or more closable passageways disposed along a side of the enclosure, the divider defining a first animal holding area having a first width and defining a second animal holding area having a second width; and
repositioning the divider within the interior area to a retracted position along the transverse axis to merge the first animal holding area and the second animal holding area to form a merged animal holding area having a width that is approximately a sum of a width of the first animal holding and a width of the second animal holding area.

17. The method of claim 16, wherein the divider includes a guide member and repositioning the divider comprises translating the guide member along the track disposed within the interior area in response to an interaction between the guide member and the track.

18. A system for confining one or more animals comprising
an enclosure extending along a longitudinal axis and defining an interior area; and
one or more dividers disposed within the interior area to form a plurality of animal holding areas, the one or more dividers being adjustably positioned along a transverse axis within the interior area to reconfigure the plurality of animal holding areas.

19. The system of claim 18, wherein the one or more dividers are adjustably positioned along the transverse axis to change a quantity of the plurality of animal holding areas formed in the interior area.

20. The system of claim 18, wherein the one or more dividers are adjustably positioned along the transverse axis to adjust a size of at least one of the plurality of animal holding areas.
